(19) United States
(12) Patent Application Publication
(10) Pub. No.: US 2018/0196897 A1
(43) Pub. Date: Jul. 12, 2018

(54) Method And Apparatus For Production Logging Tool (PLT) Results Interpretation

(71) Applicant: Halliburton Energy Services, Inc., Houston, TX (US)

(72) Inventors: Andrey Filippov, Houston, TX (US); Vitaly Khoriakov, Calgary (CA); Gustavo Carvajal, Katy, TX (US)

(21) Appl. No.: 15/741,960

(22) PCT Filed: Aug. 21, 2015
(86) PCT No.: PCT/US15/46397

§ 371 Date: Jan. 4, 2018

(51) Int. Cl. G06F 17/50; E21B 47/10; G01V 3/18

(52) U.S. Cl. CPC G06F 17/5009; G01V 3/18; E21B 47/10

(57) ABSTRACT

Methods and systems are presented in this disclosure for evaluation of formation properties (e.g., permeability, saturation) based on interpretation of data obtained by production logging tools (PLTs). Based on the PLT data, a production rate for a component (e.g., production fluid) produced by a wellbore can be determined, and a distribution of a property of the component can be initialized along a length of the wellbore. A simulated production rate for the component can be calculated, based on the distribution of the property using a simulator for the wellbore. The distribution of the property can be iteratively adjusted based on the production rate and the simulated production rate, until convergence of the distribution for two consecutive iterations is achieved. A reservoir formation model used for operating the wellbore can be updated based on the adjusted distribution of the property of the component.

### TECHNICAL FIELD

The present disclosure generally relates to interpretation of data obtained by production logging tools (PLTs) used in hydrocarbon wells and, more particularly, to a method and apparatus for evaluation and validation of formation properties based on interpretation of data results obtained by PLTs.

### BACKGROUND

Production logging tools (PLTs) are routinely used in production hydrocarbon wells to determine the distribution of oil, gas and water production along a well in cases when the well experiences perforations over a sufficiently large interval. Typically, the PLT tool string can be composed of flow meters, pressure gauges, temperature gauges, and a fluid density or a capacitance tool. The downhole data obtained by PLTs can be, for example, transmitted electronically to a surface via an electrical cable. At the surface, PLT data can be processed and utilized for reservoir management in areas such as void control, pressure maintenance, and evaluation or validation of formation properties.

The most commonly used method in the prior art for evaluation and/or validation of formation properties (e.g., permeability profiles of production components along a wellbore, saturation profiles, and the like) is the try-and-error approach, where a user (e.g., an engineer) modifies manually the formation properties (e.g., permeability and relative permeability profiles), running wellbore simulators multiple times. The process of matching performed in the try-and-error method can be highly time consuming, and may not yield the preferred approximation to actual distributions, particularly in multiphase production cases. The other method in the prior art used for evaluation and/or validation of formation properties (e.g., permeability profiles and saturation profiles) is based on minimizing an objective (e.g., cost) function. For example, the objective function can be built by integrating the square of difference between observed data (e.g., PLT log data) and a modeled property (e.g., a flow rate) based on an assumption of a certain permeability profile. Thus, the method based on minimizing objective function is actually reduced to finding a minimum of a function of n variables, where n is a dimension of PLT log data (i.e., a number of measurement points). Because the dimension of PLT log data can be rather high (e.g., hundreds and above), the approach based on minimizing the objective function usually leads to impractical central processing unit (CPU) time requirements, particularly for advanced (e.g., three-dimensional (3D)) wellbore/reservoir simulators. Yet another method in the prior art used for evaluation and/or validation of formation properties (e.g., permeability profiles and saturation profiles) is based on pressure buildup data for transient (e.g., shut-in) tests. However, this method cannot be used for interpretation of steady state velocity log data.

Therefore, an efficient and accurate method and framework for evaluation and validation of formation properties (e.g., formation permeability and saturation profiles) based on interpretation of PLT log data is desirable.

### BRIEF DESCRIPTION OF THE DRAWINGS

Various embodiments of the present disclosure will be understood more fully from the detailed description given below and from the accompanying drawings of various embodiments of the disclosure. In the drawings, like reference numbers may indicate identical or functionally similar elements.

FIG. 1 is an example view of a wellbore with oil, gas and water inflow, according to certain embodiments of the present disclosure.

FIG. 2 is an example of a production logging tool (PLT), according to certain embodiments of the present disclosure.

FIG. 3 is an example graph of PLT log data related to a hydrocarbon well, according to certain embodiments of the present disclosure.

FIG. 4 is a flowchart of an iterative method for determining permeability distribution (profile) of a component in a reservoir formation along a wellbore, according to certain embodiments of the present disclosure.

FIG. 5 is an example graph of normalized permeability profile used to model a PLT velocity log and the permeability profile retrieved using the iterative method presented herein, according to certain embodiments of the present disclosure.

FIG. 6 is an example graph of modeled PLT velocity log and velocity profile calculated using the permeability profile evaluated after applying the iterative method presented herein, according to certain embodiments of the present disclosure.

FIG. 7 is an example graph of modeled PLT velocity log with a certain noise level and velocity profile calculated using the permeability profile evaluated after applying the iterative method presented herein, according to certain embodiments of the present disclosure.

FIG. 8 is an example graph of normalized permeability profile used to model a PLT velocity log and permeability profile retrieved after applying the iterative method presented herein for noisy PLT data, according to certain embodiments of the present disclosure.

FIG. 9 is a flow chart of a method for evaluation of formation properties based on interpretation of PLT data, according to certain embodiments of the present disclosure.

FIG. 10 is a block diagram of an illustrative computer system in which embodiments of the present disclosure may be implemented.

### DETAILED DESCRIPTION

Embodiments of the present disclosure relate to a method and apparatus for evaluation of formation properties (e.g., permeability profiles of components in a reservoir formation along a wellbore, saturation profiles, and the like) based on interpretation of data obtained by production logging tools (PLTs) used in hydrocarbon wells. While the present disclosure is described herein with reference to illustrative embodiments for particular applications, it should be understood that embodiments are not limited thereto. Other embodiments are possible, and modifications can be made to the embodiments within the spirit and scope of the teachings herein and additional fields in which the embodiments would be of significant utility.

In the detailed description herein, references to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments whether or not explicitly described. It would also be apparent to one skilled in the relevant art that the embodiments, as described herein, can be implemented in many different embodiments of software, hardware, firmware, and/or the entities illustrated in the figures. Any actual software code with the specialized control of hardware to implement embodiments is not limiting of the detailed description. Thus, the operational behavior of embodiments will be described with the understanding that modifications and variations of the embodiments are possible, given the level of detail presented herein.

The disclosure may repeat reference numerals and/or letters in the various examples or Figures. This repetition is for the purpose of simplicity and clarity and does not in itself dictate a relationship between the various embodiments and/or configurations discussed. Further, spatially relative terms, such as beneath, below, lower, above, upper, uphole, downhole, upstream, downstream, and the like, may be used herein for ease of description to describe one element or feature's relationship to another element(s) or feature(s) as illustrated, the upward direction being toward the top of the corresponding figure and the downward direction being toward the bottom of the corresponding figure, the uphole direction being toward the surface of the wellbore, the downhole direction being toward the toe of the wellbore. Unless otherwise stated, the spatially relative terms are intended to encompass different orientations of the apparatus in use or operation in addition to the orientation depicted in the Figures. For example, if an apparatus in the Figures is turned over, elements described as being “below” or “beneath” other elements or features would then be oriented “above” the other elements or features. Thus, the exemplary term “below” can encompass both an orientation of above and below. The apparatus may be otherwise oriented (rotated 90 degrees or at other orientations) and the spatially relative descriptors used herein may likewise be interpreted accordingly.

Moreover even though a Figure may depict a horizontal wellbore or a vertical wellbore, unless indicated otherwise, it should be understood by those skilled in the art that the apparatus according to the present disclosure is equally well suited for use in wellbores having other orientations including vertical wellbores, slanted wellbores, multilateral wellbores or the like. Likewise, unless otherwise noted, even though a Figure may depict an offshore operation, it should be understood by those skilled in the art that the apparatus according to the present disclosure is equally well suited for use in onshore operations and vice-versa. Further, unless otherwise noted, even though a Figure may depict a cased hole, it should be understood by those skilled in the art that the apparatus according to the present disclosure is equally well suited for use in open hole operations.

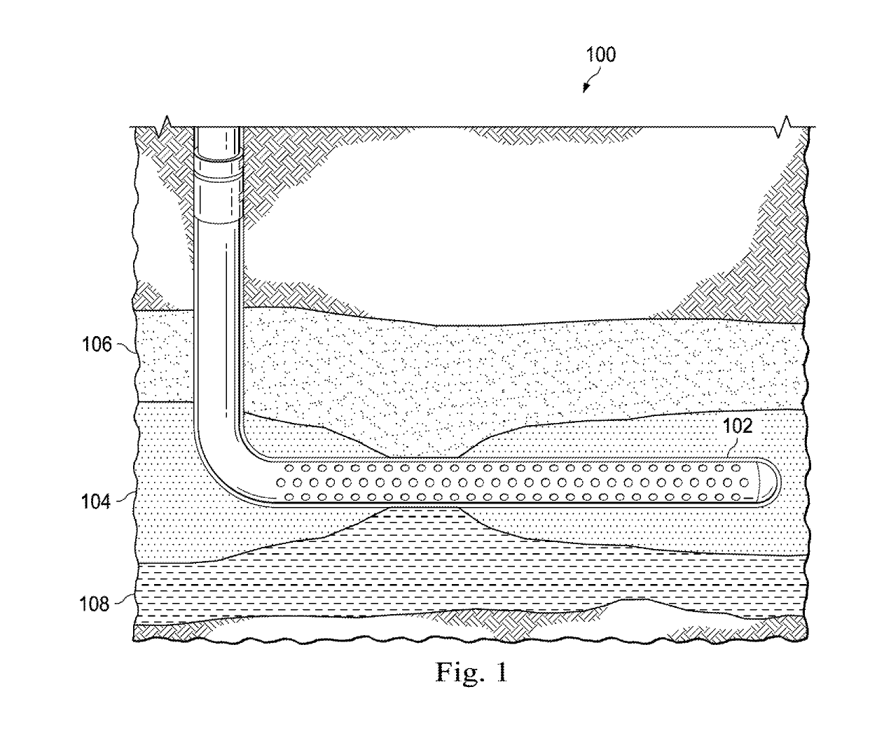

Illustrative embodiments and related methods of the present disclosure are described below in reference to FIGS. 1-10 as they might be employed for evaluation of formation properties (e.g., permeability profiles, saturation profiles, and the like) based on interpretation of data obtained by PLTs used in hydrocarbon wells. Such embodiments and related methods may be practiced, for example, using a computer system as described herein. Other features and advantages of the disclosed embodiments will be or will become apparent to one of ordinary skill in the art upon examination of the following figures and detailed description. It is intended that all such additional features and advantages be included within the scope of the disclosed embodiments. Further, the illustrated figures are only exemplary and are not intended to assert or imply any limitation with regard to the environment, architecture, design, or process in which different embodiments may be implemented.

A numerical method is presented in this disclosure for evaluation and validation of formation properties based on interpretation of data obtained by PLTs. In one or more embodiments, the numerical method presented herein would yield a permeability profile of a reservoir formation and/or saturations of production fluids along a length of a wellbore associated with the reservoir formation. The method presented herein is illustrated by numerical examples, where modeled PLT data are used and simulated using actual distribution of reservoir absolute permeability and the hydrodynamic solver of NETool® wellbore/completions simulator. The presented method is general and can be applied for determining permeability and saturation profiles of various phases of a multiphase production flow. In one or more embodiments, a series of information are mandatory to proceed with the calculation of permeability profile across the wellbore. One of the essential data is pressure-volume-temperature (PVT) data, wellbore completions data including a tubing size, casing specifications, perforations details, skin data, a vertical lift performance table, and validated and updated 3-phase relative permeability tables with gas, oil and water saturations.

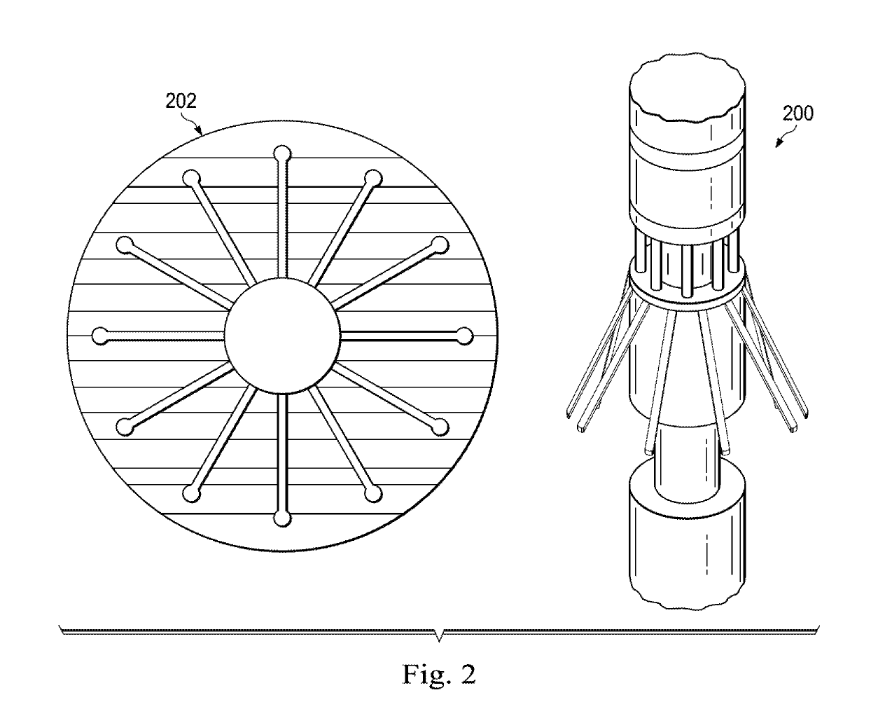

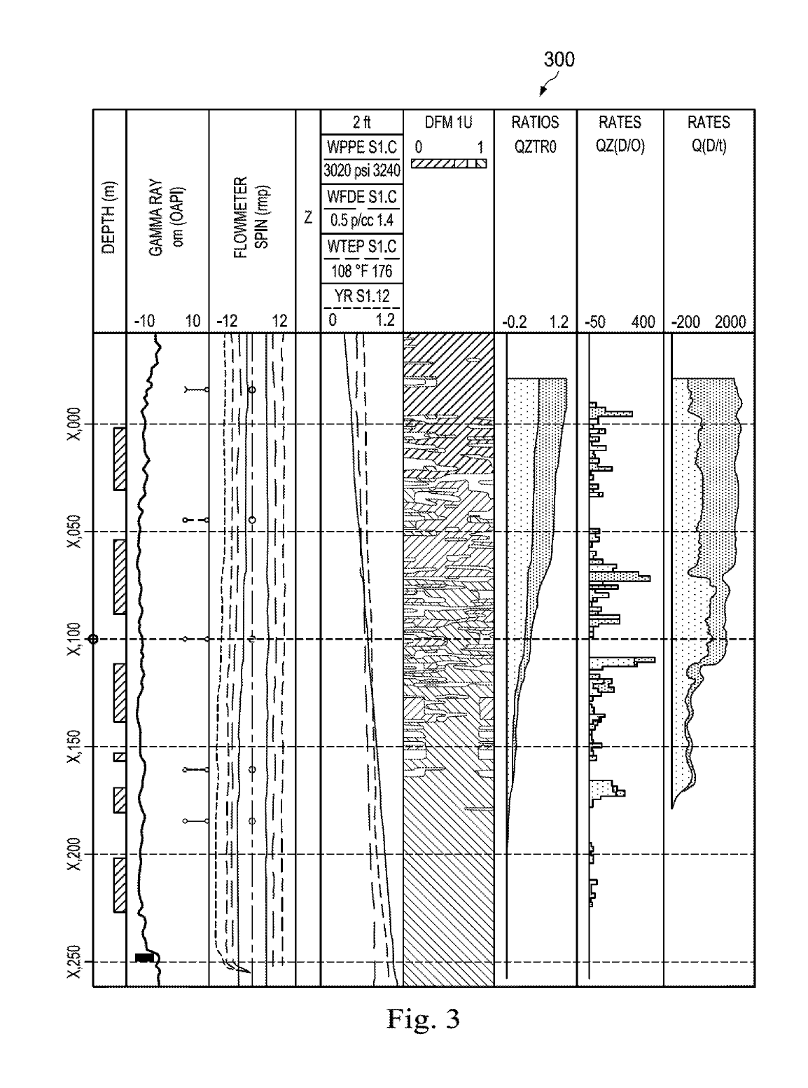

Certain embodiments of the present disclosure may be related to, but not limited to, a horizontal well in a formation situated above an aquifer, as illustrated in FIG. 1. FIG. 1 illustrates an example view 100 of a wellbore 102 with inflow of oil 104, gas 106 and water 108, according to certain embodiments of the present disclosure. PLT log data obtained by PLT logging tool(s), such as an example PLT logging tool 200 with a cross-sectional view 202 illustrated in FIG. 2, may allow calculating an influx (i.e., a mass flow rate per unit length of well) Jᵢ of all components i (e.g., oil, water and gas) into the wellbore, i.e.,

$$r = {r}_{0} \text{:} {J}_{i} = - \frac{2 π {k}_{i} {r}_{0}}{{v}_{i}} \cdot \frac{\partial p}{\partial r} ; i = o , g , w , \qquad ( 1 )$$

where r is the radial coordinate, rₒ is the wellbore radius, kᵢ and vᵢ are the permeability and kinematic viscosity of the i-th component (e.g., oil, gas and water), respectively. FIG. 3 illustrates an example graph 300 of PLT log data (e.g., obtained by the PLT logging tool 200) that can be used for calculating the influx Jᵢ according to equation (1).

Values of the material properties (e.g., the wellbore radius, a kinematic viscosity vᵢ of a particular i-th component) and the gradient of pressure p

$$( i . e . , \frac{\partial p}{\partial r}$$

in equation (1)) can be taken at the completion face on the formation side. In one or more embodiments, by knowing the mass flow rates defined by equation (1), it is possible to determine the component permeabilities in the vicinity of the wellbore, even if the pressure gradient is not known. For example, the measured oil production rate Jₒ in the wellbore location of interest is non-zero and can be determined from PLT log data. Then, the following ratios can be defined:

$${f}_{g} = \frac{{k}_{g}}{{k}_{o}} \cdot \frac{{v}_{o}}{{v}_{g}} ; {f}_{w} = \frac{{k}_{w}}{{k}_{o}} \cdot \frac{{v}_{o}}{{v}_{w}} ; \\ {J}_{i} = - \frac{2 π {k}_{i} {r}_{0}}{{v}_{i}} \cdot \frac{\partial p}{\partial r} ; i = o , g , w . \qquad ( 2 )$$

Because all of the production rates Jᵢ and the ratios f_{g} and f_{w} defined by equation (2) are known, all of the permeability profiles along the wellbore can be found, if a profile of the oil permeability kₒ is determined, i.e.,

$${k}_{g} = \frac{{v}_{g}}{{v}_{o}} \cdot {k}_{o} ; {k}_{w} = \frac{{v}_{w}}{{v}_{o}} \cdot {k}_{o} . \qquad ( 3 )$$

For certain embodiments, individual viscosities of components are known from a laboratory test or PVT data. Because the relative permeabilities are functions of their saturations, equation (3) can be also applied to determine the saturation profiles. According to equation (3), even in the multicomponent case, the process of retrieving the relative permeabilities and saturations can be reduced to finding a permeability profile of a single component. Therefore, an inversion algorithm developed for a single-phase production case can be applied to the multiphase case using equations (2)-(3).

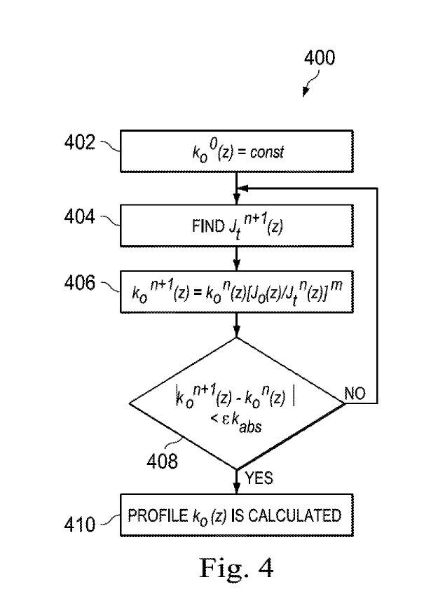

Embodiments of the present disclosure can further relate to an illustrative wellbore (e.g., the wellbore 102 illustrated in FIG. 1) producing only one component, i.e., oil with known distribution of production rate Jₒ(z) determined from PLT log data. In order to find the distribution of the oil permeability kₒ(z) along the length z of the wellbore, the function Jₒ(z) is compared with theoretical predictions for production rate Jₜ(z), which can be obtained using a wellbore simulator. The method presented in this disclosure is an iterative framework illustrated as a flowchart 400 in FIG. 4. Initially (i.e., for the iteration number n=0), at block 402, the oil permeability profile kₒ(z) is initialized to be constant along the length of the wellbore, i.e., kₒⁿ⁼⁰(z)=const. At block 404, by using a wellbore solver, a profile of theoretical oil production rate Jₜⁿ(z) may be calculated for an estimated (evaluated) permeability profile kₒⁿ(z). At block 406, the permeability profile may be corrected (adjusted) using PLT log data (e.g., distribution of production rate Jₒ(z)) and the theoretical production profile Jₜⁿ(z). In one or more embodiments, the permeability distribution function (permeability profile) may be modified, at block 406, according to:

kₒⁿ⁺¹(z)=kₒⁿ(z)·F[Jₒ(z),Jₜⁿ(z)], (4)

where n is the iteration number; and the function F[⋅] is chosen such that F[⋅]>1 if the theoretical prediction of the local production rate at n-th iteration Jₜⁿ(z) is smaller than its measured value Jₒ(z), while F[⋅]<1 in the opposite case. In an embodiment, as illustrated in FIG. 4, the function F in equation (4) may be defined as:

F[Jₒ(z),Jₜⁿ(z)]=[Jₒ(z)/Jₜⁿ(z)]^{m}, (5)

where m is a positive integer.

At block 408, the convergence of permeability profile may be checked by comparing permeability profiles of two successive iterations n and n+1, i.e.,

max|kₒⁿ⁺¹(z)−kₒⁿ(z)|<ε·k_{abs}, (6)

where ε is a pre-determined small number (e.g., ε=10⁻⁶) and k_{abs} is the absolute permeability of the reservoir formation. If the condition defined by equation (6) is not fulfilled, the convergence of permeability profile is not yet achieved and the iterative process (e.g., the framework 400 illustrated in FIG. 4) may continue from block 408 back to block 404 by determining the theoretical oil production rate Jₜⁿ⁺¹(z) for the next iteration n+1 based on the estimated permeability profile kₒⁿ⁺¹(z). If the condition defined by equation (6) is satisfied, the permeability profile converges and the permeability profile kₒ(z) along the length of the wellbore is calculated, i.e., kₒ(z)=kₒⁿ⁺¹(z) as illustrated in block 410 of the framework 400 in FIG. 4.

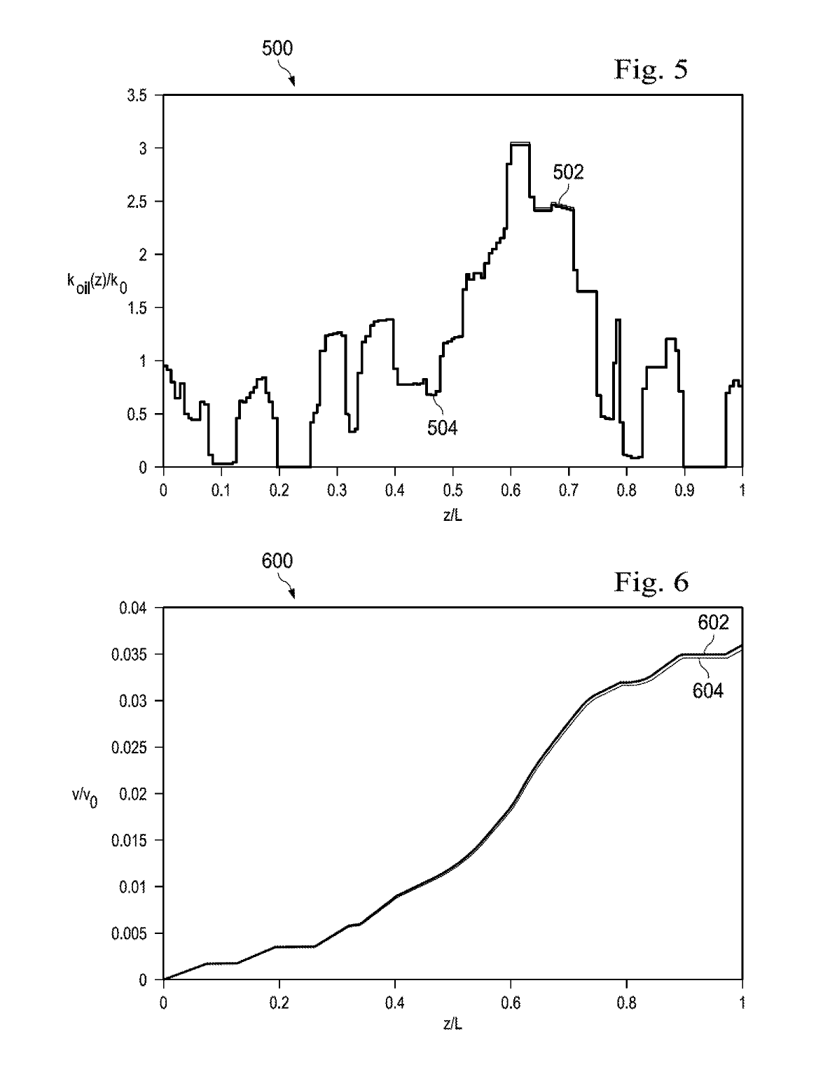

FIG. 5 illustrates an example graph 500 of a normalized profile of oil permeability (plot 502) used to model a PLT velocity log and an evaluated profile of oil permeability (plot 504) retrieved after applying eight iterations of the iterative method presented herein (e.g., the framework 400 illustrated in FIG. 4). In the example graph 500 in FIG. 5, k₀ represents a reference permeability value. In order to validate the iterative method presented herein (e.g., the framework 400 illustrated in FIG. 4), the actual permeability profile (e.g., plot 502) along a real wellbore with length L is employed, wherein the well is producing only one component (e.g., oil). The actual permeability distribution (e.g., plot 502) is utilized to generate a model PLT log—axial profile of the flow velocity, illustrated by plot 602 in FIG. 6. The actual oil production rate distribution Jₒ(z) is obtained by numerical differentiation of the flow profile illustrated by plot 602 in FIG. 6. Eight iterations of the presented iterative method (e.g., the framework 400 illustrated in FIG. 4) is carried out to retrieve the distribution of oil permeability, illustrated with plot 504 in FIG. 5. It can be observed from FIG. 5 that the evaluated permeability distribution illustrated with plot 504 is practically identical to the actual permeability profile illustrated with plot 502. The evaluated permeability distribution 504 is used to generate the flow velocity profile illustrated with plot 604 in FIG. 6. It can be observed from FIG. 6 that the evaluated flow velocity profile illustrated with plot 604 is practically identical to the modeled PLT log velocity profile illustrated with plot 602.

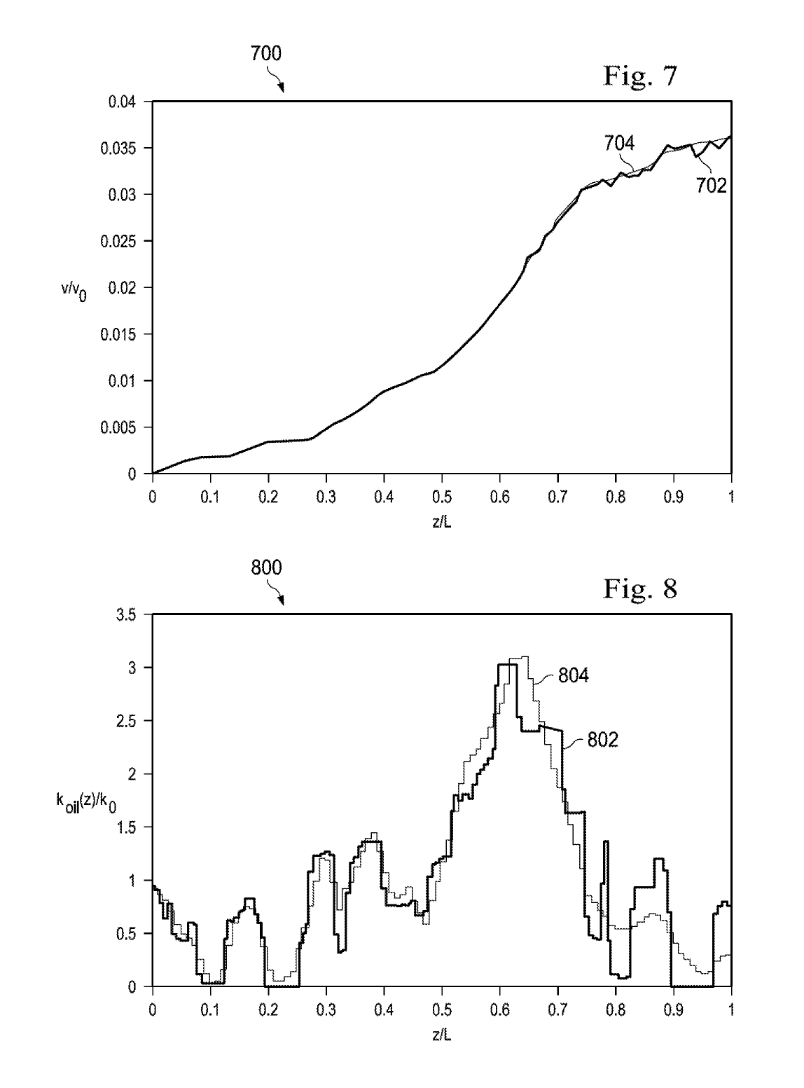

Some measurement errors always exist in real PLT log data. In order to simulate the measurement errors, the random noise of 2.5% relative level is added to the modeled log data. FIG. 7 illustrates a modeled PLT velocity log with 2.5% relative noise level shown with plot 702. Velocity profile calculated using the evaluated permeability profile after 8 iterations of the iterative method presented herein is illustrated with plot 704 in FIG. 7. FIG. 8 illustrates a normalized profile of oil permeability used to model the PLT velocity log shown with plot 802. Application of the presented iterative method (e.g., 18 iterations of the framework 400 illustrated in FIG. 4) yields the profile of oil permeability illustrated with plot 804 in FIG. 8. It can be observed that the evaluated permeability profile is very accurate in the parts of the wellbore with low absolute noise level (e.g., left sides of FIGS. 7-8), while in other parts of the wellbore presence of the noise of relatively high amplitude resulted in somewhat lower accuracy of interpretation (e.g., right sides of FIGS. 7-8).

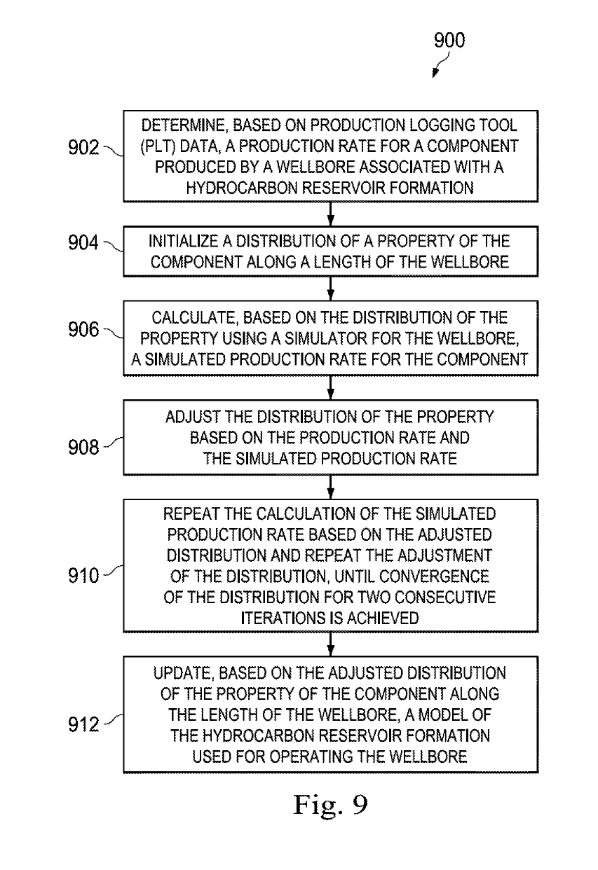

Discussion of an illustrative method of the present disclosure will now be made with reference to FIG. 9, which is a flow chart 900 of a method for evaluation of formation properties (e.g., permeability profiles, saturation profiles, and the like) based on interpretation of PLT data, according to certain embodiments of the present disclosure. The method begins at 902 by determining, based on the PLT data, a production rate (e.g., the rate Jₒ(z) in the iterative framework 400 illustrated in FIG. 4) for a component (e.g., production fluid or oil) produced by a wellbore associated with a hydrocarbon reservoir formation. At 904, a distribution of a property of the component (e.g., permeability profile of oil) may be initialized. At 906, a simulated production rate (e.g., the rate Jₜ(z) in the iterative framework 400 illustrated in FIG. 4) for the component may be calculated using a simulator for the wellbore, based on the distribution of the property of the component (e.g., the initialized permeability profile or the permeability profile evaluated at a current iteration of the iterative method 900). At 908, the distribution of the property of the component may be adjusted based on the production rate (e.g., the rate Jₒ(z)) and the simulated production rate (e.g., the rate Jₜ(z)). At 910, the calculation of the simulated production rate (e.g., the rate Jₜⁿ⁺¹(z) for the next iteration of the framework 400 in FIG. 4) based on the adjusted distribution (e.g., the estimated permeability profile kₒⁿ⁺¹(z)) may be repeated and the adjustment of the distribution may be repeated (e.g., iterative repetition of blocks 404 and 406 in the iterative framework 400 illustrated in FIG. 4), until convergence of the distribution for two consecutive iterations is achieved (e.g., decided in block 408 in the iterative framework 400 illustrated in FIG. 4). At 912, based on the adjusted distribution of the property of the component along the length of the wellbore, a model (e.g., characterization) of the hydrocarbon reservoir formation used for operating the wellbore may be updated.

In one or more embodiments, the distribution of the property of the component may comprise a distribution of a permeability of the component along a length of the wellbore, and the component may comprise a production fluid such as oil. Based on the distribution of the permeability of the production fluid along the wellbore, a distribution of a saturation of the production fluid along the length of the wellbore may be determined.

For certain embodiments, initializing the distribution of the property may comprise setting the distribution to a predefined value constant along a length of the wellbore (e.g., as defined in block 402 of the iterative framework 400 illustrated in FIG. 4). For certain embodiments, adjusting the distribution (e.g., performed in block 406 of the iterative framework 400 illustrated in FIG. 4) may comprise: increasing a value of the distribution for a length of the wellbore, if the simulated production rate is smaller than the production rate for the length of the wellbore, and decreasing the value of the distribution for the length of the wellbore, if the simulated production rate is larger than the production rate for the length of the wellbore.

In one or more embodiments, the convergence may be achieved if a difference between two values of the distribution for the two consecutive iterations associated with a same length of the wellbore is smaller than a threshold, as defined by equation (6). The distribution of the property of the component may comprise a distribution of a permeability of the component along a length of the wellbore, and the threshold may be based on an absolute permeability of the hydrocarbon reservoir formation, k_{abs} defined in equation (6).

For certain embodiments, the component may comprise an oil, and the distribution of the property may comprises a distribution of a permeability of the oil along a length of the wellbore (e.g., kₒ(z)). In one or more embodiments, a permeability profile of a gas (e.g., k_{g}(z)) and a permeability profile of a water (e.g., k_{w}(z)) along the length of the wellbore may be determined based on the distribution of the permeability of the oil (e.g., by applying equation (3)). In one or more other embodiments, based on the distribution of the permeability of the oil, a saturation profile of the oil along the length of the wellbore may be determined. Further, a saturation profile of the gas and a saturation profile of the water along the length of the wellbore may be determined based on the saturation profile of the oil.

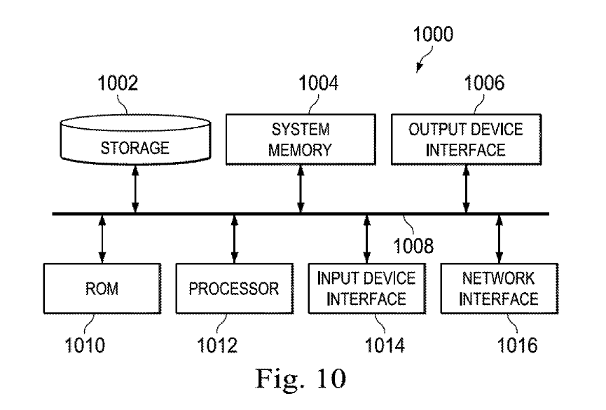

FIG. 10 is a block diagram of an illustrative computing system 1000 in which embodiments of the present disclosure may be implemented adapted for evaluation of formation properties (e.g., permeability profiles along a wellbore, saturation profiles, and the like) based on interpretation of PLT data obtained for a hydrocarbon well. For example, the operations of framework 400 from FIG. 4 and the operations of method 900 of FIG. 9, as described above, may be implemented using the computing system 1000. The computing system 1000 can be a computer, phone, personal digital assistant (PDA), or any other type of electronic device. Such an electronic device includes various types of computer readable media and interfaces for various other types of computer readable media. As shown in FIG. 10, the computing system 1000 includes a permanent storage device 1002, a system memory 1004, an output device interface 1006, a system communications bus 1008, a read-only memory (ROM) 1010, processing unit(s) 1012, an input device interface 1014, and a network interface 1016.

The bus 1008 collectively represents all system, peripheral, and chipset buses that communicatively connect the numerous internal devices of the computing system 1000. For instance, the bus 1008 communicatively connects the processing unit(s) 1012 with the ROM 1010, the system memory 1004, and the permanent storage device 1002.

From these various memory units, the processing unit(s) 1012 retrieves instructions to execute and data to process in order to execute the processes of the subject disclosure. The processing unit(s) can be a single processor or a multi-core processor in different implementations.

The ROM 1010 stores static data and instructions that are needed by the processing unit(s) 1012 and other modules of the computing system 1000. The permanent storage device 1002, on the other hand, is a read-and-write memory device. This device is a non-volatile memory unit that stores instructions and data even when the computing system 1000 is off. Some implementations of the subject disclosure use a mass-storage device (such as a magnetic or optical disk and its corresponding disk drive) as the permanent storage device 1002.

Other implementations use a removable storage device (such as a floppy disk, flash drive, and its corresponding disk drive) as the permanent storage device 1002. Like the permanent storage device 1002, the system memory 1004 is a read-and-write memory device. However, unlike the storage device 1002, the system memory 1004 is a volatile read-and-write memory, such a random access memory. The system memory 1004 stores some of the instructions and data that the processor needs at runtime. In some implementations, the processes of the subject disclosure are stored in the system memory 1004, the permanent storage device 1002, and/or the ROM 1010. For example, the various memory units include instructions for computer aided pipe string design based on existing string designs in accordance with some implementations. From these various memory units, the processing unit(s) 1012 retrieves instructions to execute and data to process in order to execute the processes of some implementations.

The bus 1008 also connects to the input and output device interfaces 1014 and 1006. The input device interface 1014 enables the user to communicate information and select commands to the computing system 1000. Input devices used with the input device interface 1014 include, for example, alphanumeric, QWERTY, or T9 keyboards, microphones, and pointing devices (also called “cursor control devices”). The output device interfaces 1006 enables, for example, the display of images generated by the computing system 1000. Output devices used with the output device interface 1006 include, for example, printers and display devices, such as cathode ray tubes (CRT) or liquid crystal displays (LCD). Some implementations include devices such as a touchscreen that functions as both input and output devices. It should be appreciated that embodiments of the present disclosure may be implemented using a computer including any of various types of input and output devices for enabling interaction with a user. Such interaction may include feedback to or from the user in different forms of sensory feedback including, but not limited to, visual feedback, auditory feedback, or tactile feedback. Further, input from the user can be received in any form including, but not limited to, acoustic, speech, or tactile input. Additionally, interaction with the user may include transmitting and receiving different types of information, e.g., in the form of documents, to and from the user via the above-described interfaces.

Also, as shown in FIG. 10, the bus 1008 also couples the computing system 1000 to a public or private network (not shown) or combination of networks through a network interface 1016. Such a network may include, for example, a local area network (“LAN”), such as an Intranet, or a wide area network (“WAN”), such as the Internet. Any or all components of the computing system 1000 can be used in conjunction with the subject disclosure.

These functions described above can be implemented in digital electronic circuitry, in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media can store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, such as application specific integrated circuits (ASICs) or field programmable gate arrays (FPGAs). In some implementations, such integrated circuits execute instructions that are stored on the circuit itself. Accordingly, the operations of framework 400 from FIG. 4 and the operations of method 900 of FIG. 9, as described above, may be implemented using the computing system 1000 or any computer system having processing circuitry or a computer program product including instructions stored therein, which, when executed by at least one processor, causes the processor to perform functions relating to these methods.

As used in this specification and any claims of this application, the terms “computer”, “server”, “processor”, and “memory” all refer to electronic or other technological devices. These terms exclude people or groups of people. As used herein, the terms “computer readable medium” and “computer readable media” refer generally to tangible, physical, and non-transitory electronic storage mediums that store information in a form that is readable by a computer.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs implemented on the respective computers and having a client-server relationship to each other. In some embodiments, a server transmits data (e.g., a web page) to a client device (e.g., for purposes of displaying data to and receiving user input from a user interacting with the client device). Data generated at the client device (e.g., a result of the user interaction) can be received from the client device at the server.

It is understood that any specific order or hierarchy of operations in the processes disclosed is an illustration of exemplary approaches. Based upon design preferences, it is understood that the specific order or hierarchy of operations in the processes may be rearranged, or that all illustrated operations be performed. Some of the operations may be performed simultaneously. For example, in certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products. Furthermore, the illustrative methods described herein may be implemented by a system including processing circuitry or a computer program product including instructions which, when executed by at least one processor, causes the processor to perform any of the methods described herein.

A computer-implemented method for interpretation of PLT data has been described in the present disclosure and may generally include: determining, based on the PLT data, a production rate for a component produced by a wellbore associated with a hydrocarbon reservoir formation; initializing a distribution of a property of the component along a length of the wellbore; calculating, based on the distribution of the property using a simulator for the wellbore, a simulated production rate for the component; adjusting the distribution of the property based on the production rate and the simulated production rate; repeating the calculation of the simulated production rate based on the adjusted distribution and repeating the adjustment of the distribution, until convergence of the distribution for two consecutive iterations is achieved; and updating, based on the adjusted distribution of the property of the component along the length of the wellbore, a model of the hydrocarbon reservoir formation used for operating the wellbore. Further, a computer-readable storage medium with instructions stored therein has been described, instructions when executed by a computer cause the computer to perform a plurality of functions, including functions to: determine, based on PLT data, a production rate for a component produced by a wellbore associated with a hydrocarbon reservoir formation; initialize a distribution of a property of the component along a length of the wellbore; calculate, based on the distribution of the property using a simulator for the wellbore, a simulated production rate for the component; adjust the distribution of the property based on the production rate and the simulated production rate; repeat the calculation of the simulated production rate based on the adjusted distribution and repeat the adjustment of the distribution, until convergence of the distribution for two consecutive iterations is achieved; and update, based on the adjusted distribution of the property of the component along the length of the wellbore, a model of the hydrocarbon reservoir formation used for operating the wellbore.

For the foregoing embodiments, the method or functions may include any one of the following operations, alone or in combination with each other: Determining, based on the distribution of the permeability of the production fluid along the length of the wellbore, a distribution of a saturation of the production fluid along the length of the wellbore; Initializing the distribution of the property comprises setting the distribution to a predefined value constant along the length of the wellbore; Adjusting the distribution comprises increasing a value of the distribution for a specific length of the wellbore, if the simulated production rate is smaller than the production rate for the specific length of the wellbore, and decreasing the value of the distribution for the specific length of the wellbore, if the simulated production rate is larger than the production rate for the specific length of the wellbore; Determining, based on the distribution of the permeability of the oil, a permeability profile of a gas along the length of the wellbore; Determining, based on the distribution of the permeability of the oil, a permeability profile of a water along the length of the wellbore; Determining, based on the distribution of the permeability of the oil, a saturation profile of the oil along the length of the wellbore; Determining, based on the saturation profile of the oil, a saturation profile of the gas along the length of the wellbore; Determining, based on the saturation profile of the oil, a saturation profile of the water along the length of the wellbore.

The distribution of the property of the component comprises a distribution of a permeability of the component along the length of the wellbore; The component comprises a production fluid; The convergence is achieved if a difference between two values of the distribution for the two consecutive iterations associated with a same length of the wellbore is smaller than a threshold; The distribution of the property of the component comprises a distribution of a permeability of the component along the length of the wellbore; The threshold is based on an absolute permeability of the hydrocarbon reservoir formation; The component comprises an oil; The distribution of the property comprises a distribution of a permeability of the oil along the length of the wellbore.

Likewise, a system for interpretation of PLT data has been described and include at least one processor and a memory coupled to the processor having instructions stored therein, which when executed by the processor, cause the processor to perform functions, including functions to: determine, based on the PLT data, a production rate for a component produced by a wellbore associated with a hydrocarbon reservoir formation; initialize a distribution of a property of the component along a length of the wellbore; calculate, based on the distribution of the property using a simulator for the wellbore, a simulated production rate for the component; adjust the distribution of the property based on the production rate and the simulated production rate; and repeat the calculation of the simulated production rate based on the adjusted distribution and repeat the adjustment of the distribution, until convergence of the distribution for two consecutive iterations is achieved.

For any of the foregoing embodiments, the system may include any one of the following elements, alone or in combination with each other: the functions performed by the processor include functions to determine, based on the distribution of the permeability of the production fluid along the length of the wellbore, a distribution of a saturation of the production fluid along the length of the wellbore; the functions performed by the processor to initialize the distribution of the property include functions to set the distribution to a predefined value constant along the length of the wellbore; the functions performed by the processor to adjust the distribution include functions to increase a value of the distribution for a specific length of the wellbore, if the simulated production rate is smaller than the production rate for the specific length of the wellbore, and decrease the value of the distribution for the specific length of the wellbore, if the simulated production rate is larger than the production rate for the specific length of the wellbore; the functions performed by the processor include functions to determine, based on the distribution of the permeability of the oil, a permeability profile of a gas along the length of the wellbore; the functions performed by the processor include functions to determine, based on the distribution of the permeability of the oil, a permeability profile of a water along the length of the wellbore; the functions performed by the processor include functions to determine, based on the distribution of the permeability of the oil, a saturation profile of the oil along the length of the wellbore; the functions performed by the processor include functions to determine, based on the saturation profile of the oil, a saturation profile of the gas along the length of the wellbore; the functions performed by the processor include functions to determine, based on the saturation profile of the oil, a saturation profile of the water along the length of the wellbore.

An efficient and accurate method and framework for determining the formation properties (e.g., permeability and saturation profiles) based on interpretation of downhole PLT log data is presented in this disclosure. The iterative method presented herein can be used for interpretation of PLT log data in both single- and multicomponent production cases. A simple numerical model can be used for implementing the described method, which can be a basis for PLT interpretation in PLT analyses.

The iterative method presented in this disclosure can be used for both dynamic and steady state data analysis. The presented method requires only several runs of a wellbore simulator, and therefore it is very fast. The method presented herein can operate with wellbore and reservoir models of a wide range of complexity. The method of the present disclosure is substantially more flexible and efficient than other available methods in the prior art.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, a phrase referring to “at least one of” a list of items refers to any combination of those items, including single members. As an example, “at least one of: a, b, or c” is intended to cover: a, b, c, a-b, a-c, b-c, and a-b-c.

While specific details about the above embodiments have been described, the above hardware and software descriptions are intended merely as example embodiments and are not intended to limit the structure or implementation of the disclosed embodiments. For instance, although many other internal components of computer system 1000 are not shown, those of ordinary skill in the art will appreciate that such components and their interconnection are well known.

In addition, certain aspects of the disclosed embodiments, as outlined above, may be embodied in software that is executed using one or more processing units/components. Program aspects of the technology may be thought of as “products” or “articles of manufacture” typically in the form of executable code and/or associated data that is carried on or embodied in a type of machine readable medium. Tangible non-transitory “storage” type media include any or all of the memory or other storage for the computers, processors or the like, or associated modules thereof, such as various semiconductor memories, tape drives, disk drives, optical or magnetic disks, and the like, which may provide storage at any time for the software programming.

Additionally, the flowchart and block diagrams in the figures illustrate the architecture, functionality, and operation of possible implementations of systems, methods and computer program products according to various embodiments of the present disclosure. It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The above specific example embodiments are not intended to limit the scope of the claims. The example embodiments may be modified by including, excluding, or combining one or more features or functions described in the disclosure.

What is claimed is:

1. A computer-implemented method for interpretation of production logging tool (PLT) data, the method comprising:
determining, based on the PLT data, a production rate for a component produced by a wellbore associated with a hydrocarbon reservoir formation;
initializing a distribution of a property of the component along a length of the wellbore;
calculating, based on the distribution of the property using a simulator for the wellbore, a simulated production rate for the component;
adjusting the distribution of the property based on the production rate and the simulated production rate;
repeating the calculation of the simulated production rate based on the adjusted distribution and repeating the adjustment of the distribution, until convergence of the distribution for two consecutive iterations is achieved; and
updating, based on the adjusted distribution of the property of the component along the length of the wellbore, a model of the hydrocarbon reservoir formation used for operating the wellbore.

2. The method of claim 1, wherein:
the distribution of the property of the component comprises a distribution of a permeability of the component along the length of the wellbore; and
the component comprises a production fluid.

3. The method of claim 2, further comprising:
determining, based on the distribution of the permeability of the production fluid along the length of the wellbore, a distribution of a saturation of the production fluid along the length of the wellbore.

4. The method of claim 1, wherein initializing the distribution of the property comprises setting the distribution to a predefined value constant along the length of the wellbore.

5. The method of claim 1, wherein adjusting the distribution comprises:
increasing a value of the distribution for a specific length of the wellbore, if the simulated production rate is smaller than the production rate for the specific length of the wellbore; and
decreasing the value of the distribution for the specific length of the wellbore, if the simulated production rate is larger than the production rate for the specific length of the wellbore.

6. The method of claim 1, wherein the convergence is achieved if a difference between two values of the distribution for the two consecutive iterations associated with a same length of the wellbore is smaller than a threshold.

7. The method of claim 6, wherein:
the distribution of the property of the component comprises a distribution of a permeability of the component along the length of the wellbore; and
the threshold is based on an absolute permeability of the hydrocarbon reservoir formation.

8. The method of claim 1, wherein
the component comprises an oil,
the distribution of the property comprises a distribution of a permeability of the oil along the length of the wellbore, and the method further comprising:
determining, based on the distribution of the permeability of the oil, a permeability profile of a gas along the length of the wellbore; and
determining, based on the distribution of the permeability of the oil, a permeability profile of a water along the length of the wellbore.

9. The method of claim 8, further comprising:
determining, based on the distribution of the permeability of the oil, a saturation profile of the oil along the length of the wellbore;
determining, based on the saturation profile of the oil, a saturation profile of the gas along the length of the wellbore; and
determining, based on the saturation profile of the oil, a saturation profile of the water along the length of the wellbore.

10. A system for interpretation of production logging tool (PLT) data, the system comprising:
at least one processor; and
a memory coupled to the processor having instructions stored therein, which when executed by the processor, cause the processor to perform functions, including functions to:
determine, based on the PLT data, a production rate for a component produced by a wellbore associated with a hydrocarbon reservoir formation;
initialize a distribution of a property of the component along a length of the wellbore;
calculate, based on the distribution of the property using a simulator for the wellbore, a simulated production rate for the component;
adjust the distribution of the property based on the production rate and the simulated production rate;
repeat the calculation of the simulated production rate based on the adjusted distribution and repeat the adjustment of the distribution, until convergence of the distribution for two consecutive iterations is achieved; and
update, based on the adjusted distribution of the property of the component along the length of the wellbore, a model of the hydrocarbon reservoir formation used for operating the wellbore.

11. The system of claim 10, wherein:
the distribution of the property of the component comprises a distribution of a permeability of the component along the length of the wellbore; and
the component comprises a production fluid.

12. The system of claim 11, wherein the functions performed by the processor include functions to:
determine, based on the distribution of the permeability of the production fluid along the length of the wellbore, a distribution of a saturation of the production fluid along the length of the wellbore.

13. The system of claim 10, wherein the functions performed by the processor to initialize the distribution of the property include functions to set the distribution to a predefined value constant along the length of the wellbore.

14. The system of claim 10, wherein the functions performed by the processor to adjust the distribution include functions to:
increase a value of the distribution for a specific length of the wellbore, if the simulated production rate is smaller than the production rate for the specific length of the wellbore; and
decrease the value of the distribution for the specific length of the wellbore, if the simulated production rate is larger than the production rate for the specific length of the wellbore.

15. The system of claim 10, wherein the convergence is achieved if a difference between two values of the distribution for the two consecutive iterations associated with a same length of the wellbore is smaller than a threshold.

16. The system of claim 15, wherein:
the distribution of the property of the component comprises a distribution of a permeability of the component along the length of the wellbore; and
the threshold is based on an absolute permeability of the hydrocarbon reservoir formation.

17. The system of claim 10, wherein
the component comprises an oil,
the distribution of the property comprises a distribution of a permeability of the oil along the length of the wellbore, and the functions performed by the processor include functions to:
determine, based on the distribution of the permeability of the oil, a permeability profile of a gas along the length of the wellbore; and
determine, based on the distribution of the permeability of the oil, a permeability profile of a water along the length of the wellbore.

18. The system of claim 17, wherein the functions performed by the processor include functions to:
determine, based on the distribution of the permeability of the oil, a saturation profile of the oil along the length of the wellbore;
determine, based on the saturation profile of the oil, a saturation profile of the gas along the length of the wellbore; and
determine, based on the saturation profile of the oil, a saturation profile of the water along the length of the wellbore.

19. A computer-readable storage medium having instructions stored therein, which when executed by a computer cause the computer to perform a plurality of functions, including functions to:
determine, based on production logging tool (PLT) data, a production rate for a component produced by a wellbore associated with a hydrocarbon reservoir formation;
initialize a distribution of a property of the component along a length of the wellbore;
calculate, based on the distribution of the property using a simulator for the wellbore, a simulated production rate for the component;
adjust the distribution of the property based on the production rate and the simulated production rate;
repeat the calculation of the simulated production rate based on the adjusted distribution and repeat the adjustment of the distribution, until convergence of the distribution for two consecutive iterations is achieved; and
update, based on the adjusted distribution of the property of the component along the length of the wellbore, a model of the hydrocarbon reservoir formation used for operating the wellbore.

20. The computer-readable storage medium of claim 19, wherein
the component comprises an oil,
the distribution of the property comprises a distribution of a permeability of the oil along the length of the wellbore, and wherein the instructions further perform functions to:
determine, based on the distribution of the permeability of the oil, a permeability profile of a gas along the length of the wellbore; and
determine, based on the distribution of the permeability of the oil, a permeability profile of a water along the length of the wellbore.
